(19) United States
(12) Patent Application Publication
(10) Pub. No.: US 2024/0080864 A1
(43) Pub. Date: Mar. 7, 2024

(54) NETWORK-ASSISTED RESOURCE REEVALUATION OR PREEMPTION

(71) Applicant: Apple Inc., Cupertino, CA (US)

(72) Inventors: Chunxuan Ye, San Diego, CA (US); Dawei Zhang, Saratoga, CA (US); Wei Zeng, Saratoga, CA (US); Weidong Yang, San Diego, CA (US); Seyed Ali Akbar Fakoorian, San Diego, CA (US); Oghenekome Oteri, San Diego, CA (US); Hong He, San Jose, CA (US); Haitong Sun, Cupertino, CA (US); Zhibin Wu, Los Altos, CA (US)

(73) Assignee: Apple Inc., Cupertino, CA (US)

(21) Appl. No.: 18/260,226

(22) PCT Filed: Dec. 20, 2021
(86) PCT No.: PCT/US2021/064318

§ 371 Date: Jun. 30, 2023

Related U.S. Application Data
(60) Provisional application No. 63/136,478, filed on Jan. 12, 2021.

(51) Int. Cl. H04W 72/40; H04W 72/02; H04W 72/04

(52) U.S. Cl. CPC H04W 72/40; H04W 72/02; H04W 72/04

(57) ABSTRACT

The present application relates to devices and components including apparatus, systems, and methods for network-assisted sidelink resource selection.

### CROSS REFERENCE TO RELATED APPLICATIONS

This application claims the benefit of U.S. Provisional Application No. 63/136,478, filed Jan. 12, 2021, which is hereby incorporated by reference in its entirety.

### BACKGROUND

Third Generation Partnership Project (3GPP) provides mechanisms for two or more user equipments (UEs) to communicate with one another over sidelink interfaces. Further study on enhancing resource allocation to facilitate sidelink communications is needed.

### BRIEF DESCRIPTION OF THE DRAWINGS

FIG. 1 illustrates a network environment in accordance with some aspects.

FIG. 2 illustrates a resource reevaluation in accordance with some aspects.

FIG. 3 illustrates a resource preemption in accordance with some aspects.

FIG. 4 illustrates an operational flow/algorithmic structure in accordance with some aspects.

FIG. 5 illustrates another operational flow/algorithmic structure in accordance with some aspects.

FIG. 6 illustrates another operational flow/algorithmic structure in accordance with some aspects.

FIG. 7 illustrates another operational flow/algorithmic structure in accordance with some aspects.

FIG. 8 illustrates another operational flow/algorithmic structure in accordance with some aspects.

FIG. 9 illustrates a user equipment in accordance with some aspects.

FIG. 10 illustrates a gNB in accordance with some aspects.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various aspects. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses. I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The teen “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

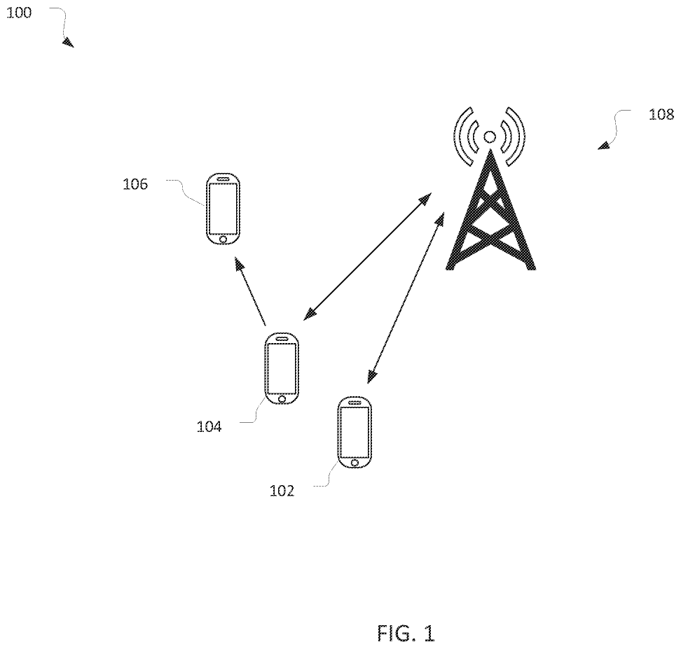

FIG. 1 illustrates a network environment 100 in accordance with some aspects. The network environment 100 may include UEs 102, 104, and 106, and a base station 108. The base station 108 may provide a wireless access cell through which one or more of the UEs 102/104/106 may communicate with the base station 108. In some aspects, the base station 108 is a gNB that provides 3GPP New Radio (NR) cell. The air interfaces over which the UEs 102/104/106 and base station 108 communicate may be compatible with 3GPP technical specifications (TSs) such as those that define Fifth Generation (5G) NR system standards.

Two or more of the UEs 102/104/106 may also communicate directly with one another over a sidelink interface. The sidelink interface may alternatively be referred to as a ProSe interface, device-to-device (D2D) interface, or a PC5 interface or reference point. In some aspects, the network environment 100 may be deployed within a vehicular communication system. In a vehicular communication system, the UEs 102/104/106 may communicate with one another using cellular vehicle-to-everything (V2X) communications. V2X may involve vehicle-to-vehicle (V2V), vehicle-to-infrastructure (V2I), vehicle-to-network (VTN), or vehicle-to-pedestrian (V2P) communications.

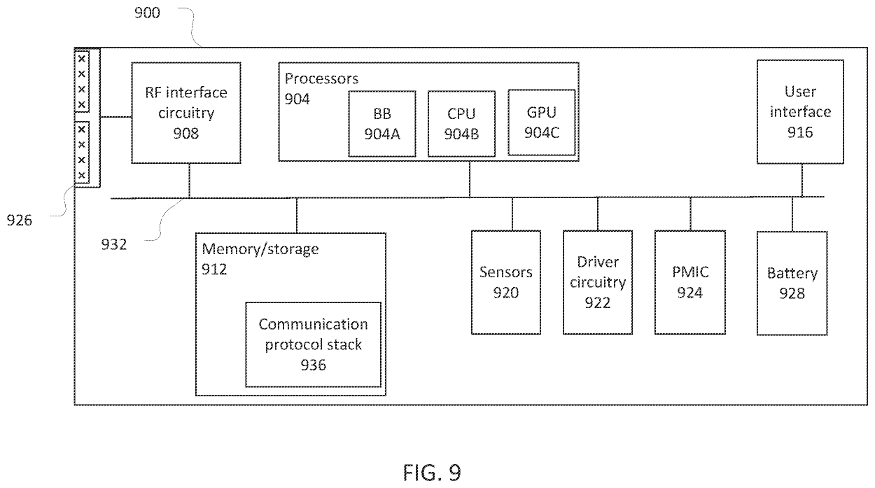

While FIG. 1 depicts the UEs 102/104/106 as mobile phones, the UEs 102/104/106 may be any type of user equipment such as those described below with respect to UE 900 of FIG. 9.

The UEs 102/104/106 may communicate with one another using a sidelink resource pool. The sidelink resource pool may include a set of time/frequency resources for sidelink transmission or reception. The sidelink resource pool may be used for all unicast, groupcast, or broadcast communications for a given UE engaging in sidelink communications. In the frequency domain, the resource pool may include a plurality of subchannels, with each sub channel including a plurality of physical resource blocks (PRBs). In various aspects, a subchannel may include 10, 12, 15, 20, 25, 50, 75, or 100 PRBs, for example. In some aspects, the PRBs of a subchannel, and the subchannels of a resource pool may be contiguous.

In the time domain, a sidelink resource pool may include a plurality of slots, which may be contiguous or noncontiguous. In some aspects, the slots for a sidelink resource pool may be configured by, for example, a bitmap transmitted by the base station 108 to indicate which slots are part of a sidelink resource pool. The bitmap may have a periodicity of 10,240 ms and a bitmap length between 10-160. In some aspects, a physical slot may include all slots including non-sidelink slots, while a logical slot may only include slots in the resource pool. For example, consider a 10-bit bitmap as follows: [1, 1, 0, 1, 1, 0, 1, 1, 1, 1]. This bitmap indicates that 10 physical slots include 8 logical slots of a sidelink resource pool.

In other aspects, the sidelink resource pool may include time or frequency domains of other sizes.

Resources of the sidelink may be allocated in a number of ways. For example, in a first mode (mode 1), the base station 108 may provide a sidelink grant to a UE. In a second mode (mode 2), a UE may sense a sidelink channel and select its own resources from the sidelink resource pool for transmission.

Mode 2 resource allocation may include a plurality of operations including, for example: resource pool configuration; sensing; resource selection; and sidelink transmission.

Resource pool configuration may include the base station 108 providing a UE with the configuration information via control signaling, for example, radio resource control (RRC) signaling. Additionally/alternatively the configuration of the resource pool may include accessing predefined configuration information stored at a UE.

After a UE is configured with a resource pool, a transmitting UE may perform a sensing procedure. Within a sensing window, the transmitting UE will decode sidelink control information (SCI) to determine a data priority indication and resource reservation information. The transmitting UE may also measure energy of the resources to determine a channel quality metric such as, for example, reference signal received power (RSRP). The sidelink RSRP measurement may be based on physical sidelink control channel (PSCCH) demodulation reference signal (DMRS) or physical sidelink shared channel (PSSCH) DMRS.

Based on the sensing operation, the UE will select resources from within a resource selection window. The resources may be selected with a subchannel granularity in the frequency domain and a slot granularity in the time domain. The UE may identify candidate resources within the resource selection window. A resource of the resource selection window may be excluded from the candidate resources if it is reserved or its associated RSRP measurement is above a predetermined threshold. The UE may then select resources from the identified candidate resources. In some aspects, the selection may be randomized.

The UE may then encode the sidelink data on the selected resources for transmission.

UEs, such as pedestrian UEs, may have reduced power capabilities as compared to vehicle-based UEs. Thus, various alternatives to the above sensing modes may be used to reduce power consumption. Some of these alternatives includes a no-sensing mode, in which random resources are selected for transmission without sensing the channel, and a partial-sensing mode, in which a UE is configured with specific monitoring periods.

The no-sensing mode enables sidelink communication for low-cost or reduced-complexity UEs. For example, a UE configured only for sidelink transmission, and not sidelink reception, which may be referred to herein as a transmit-only UE, may be an important part of pedestrian UEs in V2X scenarios. For example, a transmit-only UE may be able to proactively announce its presence, or convey other alerts, to notify other road users. Without requiring receive operations in the sidelink, there is no need for sidelink discontinuous reception (DRX) and significant power savings may be achieved.

In some aspects, a transmit-only UE may be considered to use type-A sidelink communication, which may be used as a reference for evaluation and design of sidelink power saving features in NR V2X Release 17. In type-A sidelink communication, the UE may not be capable of performing any reception of any sidelink signals or channels, with the possible exception of performing physical sidelink feedback channel or sidelink synchronization signal block (S-SSB) reception.

For purposes of the present description, the UE 104 may be considered to be a transmit-only UE. For example, the UE 104 may transmit on a sidelink channel to the UE 106 but may not receive communications directly from the UE 106 over the sidelink channel. The UE 104 may be connected to the cell provided by base station 108 and may be capable of transmitting communications to the base station 108 and receiving communications from the base station 108.

In some aspects, the UE 104 may be a transmit-only UE because it lacks the resources to receive sidelink communications, for example, the UE 104 may not include a sidelink receiver. In other aspects, the UE 104 may be capable of receiving sidelink communications, but may be configured in a transmit-only operating mode in which, for example, the sidelink receiver is deactivated. For example, the UE 104 may be periodically or dynamically configured to operate using type-A sidelink communications.

A transmit-only UE does not perform any sensing operation and may randomly select resources from a resource pool. Randomly selected resources may have a large collision probability. Thus, various aspects describe how to reduce a collision probability for a transmit-only UE that is unable to monitor the sidelink channel. Some aspects describe utilizing the base station 108 to assist by providing various operations to support resource reevaluation or preemption (RRP). In particular, aspects describe the base station 108 providing sensing results to the UE 104 to allow the UE to perform resource reevaluation or preemption based on the sensing results. The sensing results may come from the base station 108 itself or from a coordinating UE, such as UE 102. Other aspects describe the base station 108 performing the RRP operations for the UE 104 and providing the results of the RRP operations to the UE 104. The base station 108 may perform the RRP operations based on sensing results from the coordinating UE 102, for example.

RRP operations may be based on sensing of the sidelink channel before transmitting. An RRP operation may include resource reevaluation or resource preemption. In some aspects, the resource preemption may follow the resource reevaluation.

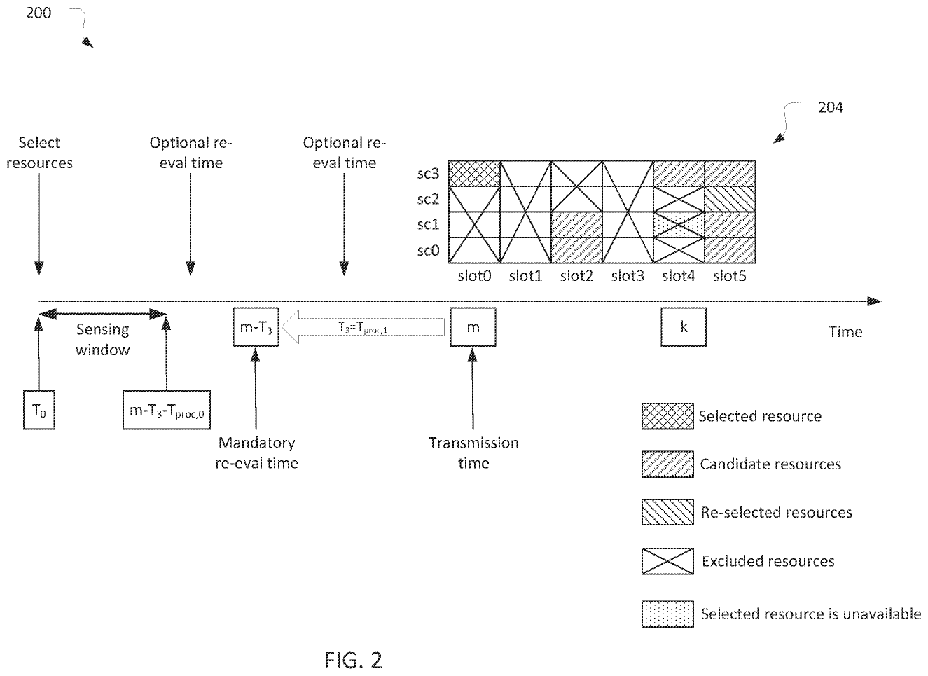

FIG. 2 illustrates a resource reevaluation 200 in accordance with some aspects. The resource reevaluation 200 may be conducted before transmission of a sidelink control information (SCI) with reservation. Thus, the resource reevaluation 200 may be related to the selection of resources before they are reserved.

The resource reevaluation 200 may be done with respect to a resource pool 204. The resource pool 204 is shown as having four subchannels (sc0-sc3) in the frequency domain and six slots (slot0-slot5) in the time domain. In other aspects, the resource pool 204 may be divided into other numbers of subchannels and slots or divided differently in the time-frequency domain.

Before T₀, the device may sense energy in various resources of the resource pool 204 and determine whether they are candidate resources or excluded resources based on comparing the sensed energy to a predetermined threshold. The device may then randomly select one or more initial resources from the candidate resources. As shown, the initially selected resources may include a first resource (sc3, slot0) and a second resource (set, slot4). For timing purposes, slot 0 may correspond to slot in, while slot 4 may correspond to slot k. At T₀, the second resource (sc1, slot4) may be considered an available, candidate resource.

After selection of initial resources at T₀, a device may continue to sense the energy of the resources of the resource pool 204 throughout a sensing window. The sensing window may be at least to m-T₃-T_{proc,0}, where T₃=T_{proc,1}, T_{proc,0} a processing time of sensing results, and T_{proc,1} is a processing time of preparing sidelink transmissions.

The device may identify the candidate resource set at least by performing a resource reevaluation at m-T₃. Sensing information after the sensing window may not need to be included in the resource reevaluation at m-T₃.

If the initially selected resources are not in the candidate resource set identified at the resource reevaluation, the device may randomly select updated resources from the identified candidate resource set. Thus, through the resource reevaluation, the device may determine whether the initially selected resources have been subsequently reserved by another UE or have otherwise become unavailable. If the device determines through the resource reevaluation that one or more of the initially selected resources have become unavailable, it may reselect a corresponding one or more resources. For example, as shown, the device may determine that the selected resource (sc1, slot4) has become unavailable and may reselect a resource in the following slot, for example, resource (sc2, slot5).

The device may also perform one or more optional reevaluations before or after the mandatory reevaluation at m-T₃. Whether the device performs these optional revaluations may depend on device implementation or configuration.

In some aspects, if, after m-T₃, a device detects that an initially selected resource is not in the candidate resource set, a resource reselection may not be required.

At a transmission time, corresponding to slot m, a UE may transmit in the first selected resource, for example, resource (sc3, slot0). The transmission may include SCI that also reserves the re-selected resource, for example, resource (sc2, slot5).

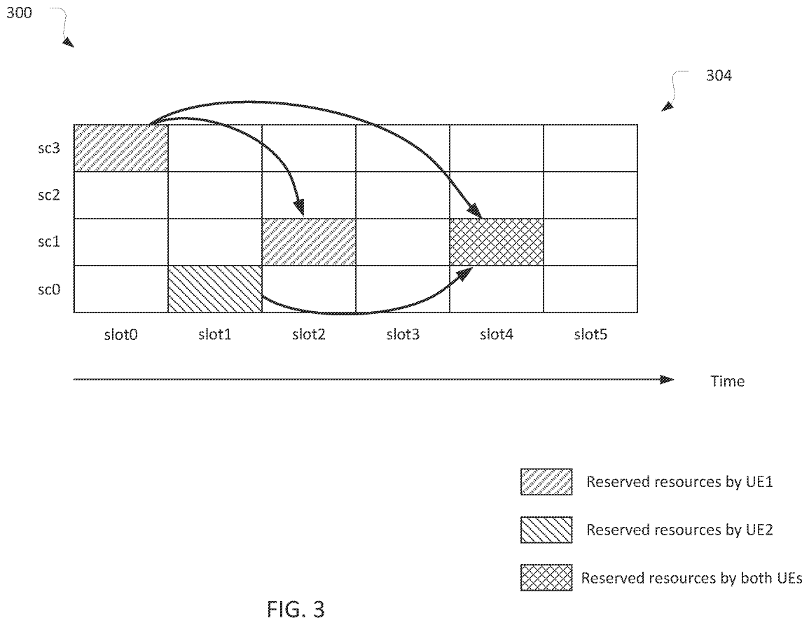

FIG. 3 illustrates a resource preemption 300 in accordance with some aspects. The resource preemption 300 may be performed with respect to two UEs (for example UE 1 and UE 2) performing sidelink communications.

The resource preemption 300 may be used to handle reserved resources. Resources selected for a UE by, for example, performing the resource reselection 200, may be preempted if the UE's reserved resources are overlapped with resources of a higher priority reservation from a different UE.

Consider, for example, that UE 1 selects three resources from resource pool 304 for transmission, resource (sc3, slot0), resource (sc1, slot2), and resource (sc1, slot4). When the UE 1 transmits a sidelink communication using resource (sc3, slot0) it may include SCI that also reserves resource (Sc, slot2) and resource (sc1, slot4). Further consider that UE 2 has selected resource (sc0, slot1) and resource (sc1, slot4). When UE 2 transmits a sidelink communication using resource (sc0, slot1) it may include SCI that also reserves resource (sc1, slot4). Thus, resource (sc1, slot4) is reserved by both UE 1 and UE 2.

The SCI that reserves a subsequent resource may also include a data priority indication to indicate a priority associated with data to be transmitted in the subsequent resource. This SCI may be broadcast or otherwise decodable by other UEs. In this manner, UE 1 and UE 2 may determine which data has a higher priority and, therefore, which transmission is preempted. For example, if the data to be transmitted by UE 2 has a relatively higher priority, the UE 1 may not use the resource (sc1, slot4) for transmission. Alternatively, if the data to be transmitted by UE 1 has a relatively higher priority, the UE 2 may not use the resource (set, slot4) for transmission.

If a first UE detects a resource reservation from a second UE, via an SCI transmitted from the second UE, the first UE may not always exclude that reserved resource. The first UE may determine whether the reservation signal from the second UE is strong (for example, a measured RSRP is above a threshold). If the measured RSRP is above the threshold, the first UE may exclude the resource. However, if the measured RSRP is not above the threshold, the second UE may be a sufficient distance from the first UE to allow the resource to be reused (for example, used by both the first and second UEs).

The UE having the relatively lower priority data may reselect resources in order to replace the overlapped resources. Both full and partial frequency domain overlap in the same slot may be considered as overlapping. Thus, the whole resource may be re-selected, even if it is only partially overlapped with a higher-priority transmission.

In some aspects, the re-selection procedure may not happen if preemption occurs at a moment later than m-714 for a preempted resource at slot m. In this case, the UE with the preempted data may restart the initial resource selection/resource reevaluation/preemption in a subsequent resource pool.

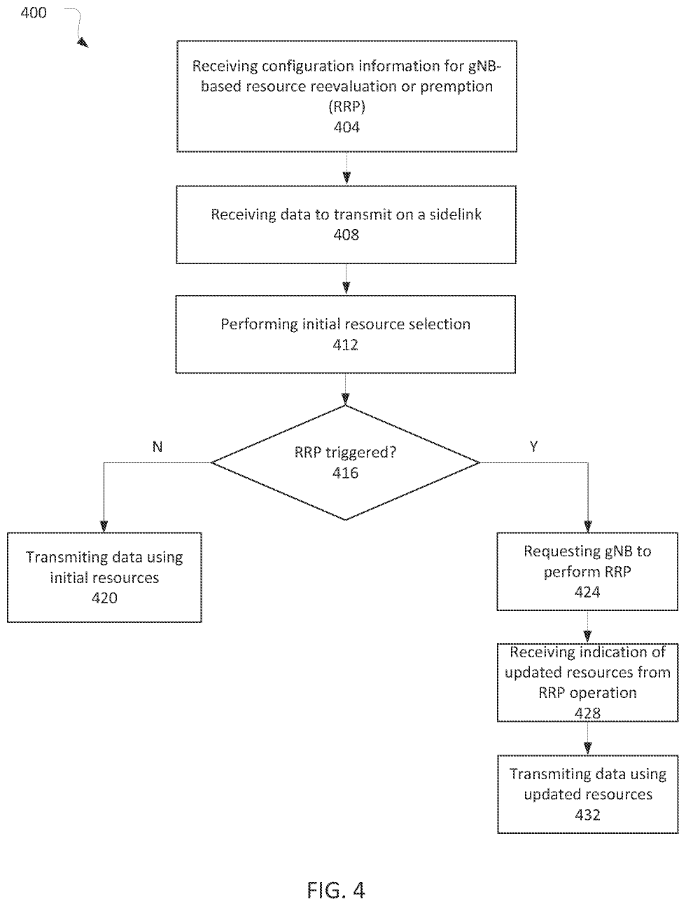

FIGS. 4-8 present a number of operation flows/algorithmic structures in accordance with aspects of this disclosure. These operation flow/algorithmic structures describe a number of operations in a particular sequence. However, the presented sequences are not restrictive. That is, the operations may be performed in sequences other than those specifically presented.

FIG. 4 illustrates an operation flow/algorithmic structure 400 in accordance with some aspects. The operation flow/algorithmic structure 400 may be performed or implemented by a transmit-only UE such as, for example, UE 104 or 900; or components thereof, for example, baseband processor 904A.

The operation flow/algorithmic structure 400 may include, at 404, receiving configuration information for a gNB-based RRP operation. In some aspects, the configuration information may include a configuration of the resource pool that is to be used for sidelink communications. In some aspects, the resource pool configuration may have an indication that a gNB-assisted RRP feature is enabled for the resource pool so that the transmit-UE may request assistance from the gNB in performing the RRP operation.

The configuration information may be received by RRC signaling. In some instances, the configuration received at 404 may be in response to a UE capability report previously transmitted to the gNB. For example, the UE may transmit a capability report that indicates the UE is a transmit-only UE. At a later time, the gNB may transmit the configuration information that configures the UE with the gNB-assisted RRP.

In some aspects, the configuration information received at 404 may include the indication that gNB-assisted RRP is enabled along with a configuration of the time-frequency resources of the resource pool. In other aspects, the configuration information may include the indication and may reference a predefined or previously configured resource pool. The predefined resource pool may be statically defined by, for example, a 3GPP TS.

The operation flow/algorithmic structure 400 may further include, at 408, receiving data to transmit on a sidelink. The data may be received at one component of the UE (for example, baseband processing circuitry) from another component of the UE (for example, a central processing unit (CPU) processing circuitry). In some aspects, the data may be associated with a priority that is based on the content of the data.

The operation flow/algorithmic structure 400 may further include, at 412, performing an initial resource selection. The initial resource selection may be a random selection of resources from the configured resource pool. In some aspects, the number of resources initially selected may be greater than a number of resources needed to transmit the data.

The operation flow/algorithmic structure 400 may further include, at 416, determining whether an RRP operation is triggered. In some aspects, the RRP operation may be triggered based on the data that is to be transmitted. A number of examples arc provided below for triggering the RRP operation. These examples are not exclusive of one another. For example, one or more of the examples may be combined and collectively serve as a basis for triggering the RRP operation.

In a first example, the RRP operation may be triggered based on a priority of the sidelink data to be transmitted. In particular, the RRP operation may be triggered for relatively high priority sidelink data and may not be triggered for relatively low priority sidelink data. Determining whether the priority of the sidelink data is sufficient to trigger the RRP operation may be based on comparing the priority to a predefined data priority threshold. The data priority threshold may be configured by the gNB or statically defined in a 3GPP TS.

In a second example, the RRP operation may be triggered based on a periodicity of the sidelink data to be transmitted. For example, periodic sidelink data may trigger the RRP operation while aperiodic sidelink data may not.

In a third example, the RRP operation may be triggered based on a packet delay budget (PDB) of the sidelink data to be transmitted. If the sidelink data has a relatively large PDB, it may be acceptable to take any extra time that may be necessary to complete the RRP operation. So, in accordance with some aspects, if the PDP of the sidelink data is larger than a predetermined threshold, the RRP may be triggered. Otherwise, the RRP may not be triggered. The predetermined threshold may be configured by the gNB or statically defined by a 3GPP TS.

In a fourth example, the RRP may be triggered based on a time interval between the random selection of the initial resources and a first-occurring resource of the initial resources. If the selected resource is more than a predetermined threshold from a time in which the resource was selected, the RRP operation may be triggered. Otherwise, the RRP operation may not be triggered. The predetermined threshold may be configured by the gNB or statically defined by a 3GPP TS.

If, at 416, it is determined that the RRP operation is not triggered, the operation flow/algorithmic structure 400 may advance to transmitting data using the initial resources at 420. In aspects in which the initial resources include more resources than needed to transmit the data, the transmit-only UE may perform a down selection of the resources by randomly selecting a subset of the initial resources. The subset may include the number of resources desired to transmit the data.

If, at 416, it is determined that the RRP operation is triggered, the operation flow/algorithmic structure 400 may advance to requesting the gNB to perform the RRP operation at 424. The request transmitted to the gNB may include information about the initial resources selected, sidelink data to be transmitted, UE information, or timing of the transmission. The request may include one or more of the following contents: a resource pool index for the selected resources; a slot index of the selected resources (time-domain information); a sub channel index and number of subchannels of each selected resource (frequency-domain information); a periodicity of the selected resources (time-domain information); a data priority of the sidelink transmission; an indication of whether the request is for a resource reevaluation or a preemption check; location information of the UE (for example, a zone ID of the transmit-on the UE): or additional information (for example, a time by which the results from the RRP are to be received).

The zone ID is typically used together with a communication range to determine whether sidelink hybrid automatic repeat request (HARQ) feedback is needed for a sidelink group cast. A transmitting UE may send a zone ID and a receiving UE may calculate the distance between the two UEs. If the distance is larger than a communication range requirement, no HARQ feedback may be necessary. In aspects of the present disclosure, if the zone ID is used for location information of the UE, it may be decoupled from the communication range feature with which it is typically used.

The request may be transmitted in a physical uplink control channel (PUCCH) (for example, a scheduling request (SR) or a buffer status report (BSR)), a physical uplink shared channel (PUSCH), an RRC message, or a MAC CE.

The operation flow/algorithmic structure 400 may further include, at 428, receiving an indication of updated resources from the RRP operation. The indication of the updated resources may indicate whether the initial resources are available or unavailable. Thus, the updated resources may include some or all of the initial resources. This indication of the updated resources may be conveyed in any of a number of ways.

In a first option, the indication may include an indicator of the available/unavailable resources for all the selected resources. For example, if the transmit-UE initially selects three resources, the indication may be a single-bit indication that indicates whether all three resources are available or not.

In a second option, the indication may include an indicator of available/unavailable resources for individual resources of the selected resources. For example, if the transmit-only UE initially selects three resources, the indication may include three bits, with each bit providing an indication of whether a corresponding initial resource is available or unavailable.

In a third option, the indication may include an indicator of available/unavailable resources for each period. The period may be based on a resource periodicity of a selected resource. For example, if the UE selects resources with a 100-slot periodicity (for example, slots 10, 110, 210, 310. . .), the gNB may provide an indicator to indicate which periods include available/unavailable resources (for example, resources in the first (slot 10), third (slot 210), and fourth periods (slot 310) are available, while resources in the second period (slot 110) are not available).

The operation flow/algorithmic structure 400 may further include, at 432, transmitting data using the updated resources. In aspects in which the updated resources include more resources than needed to transmit the data, the transmit-only UE may perform a down selection of the resources by randomly selecting a subset of the updated resources. The subset may include the number of resources desired to transmit the data.

If the resources initially selected are not available (for example, all the initial resources are not available to be used as the updated resources), the transmit-only UE may stop the sidelink transmission and either perform a random resource reselection or request another gNB-assisted RRP operation. In essence, the operation flow/algorithmic structure 400 may loop back to block 412.

If only a subset of the resources initially selected are available to be used as the updated resources, the transmit-only UE may transmit the sidelink data on the available/updated resources and may not transmit sidelink data on the unavailable resources. In the event the available/updated resources do not include a sufficient number of resources for transmission of the sidelink data, additional resources may be randomly selected as needed.

In the event no RRP results are received, the transmit-only UE may proceed to transmit the sidelink data on the initial resources or, alternatively, send an additional request to the gNB for the gNB-assisted RRP. This action may be based on configuration of the UE or the resource pool.

In some aspects, the performing of the initial resource selection at 412 may be performed after the determination of whether the RRP is triggered at 416. This may allow an adjustment of the selection window used in the initial resource selection based on whether the RRP operation is triggered or not. For example, if the RRP is triggered, the transmit-only UE may use a larger (or later) resource selection window (for example, window from which the resources are selected) than a situation in which the RRP is not triggered. Thus, the starting/ending time of the resource selection window may depend on whether RRP is triggered or not.

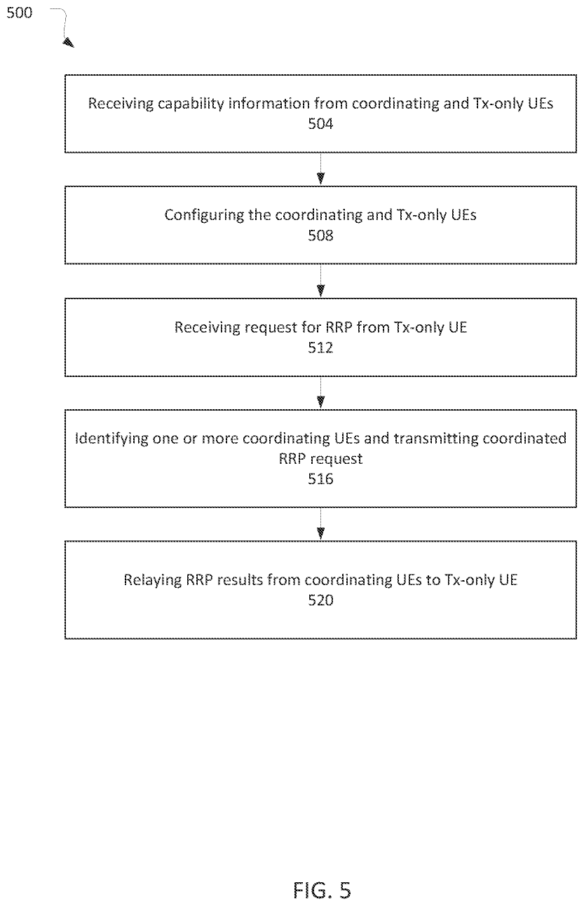

FIG. 5 illustrates an operation flow/algorithmic structure 500 in accordance with some aspects. The operation flow/algorithmic structure 500 may be performed or implemented by a gNB such as, for example, base station 108 or gNB 1000; or components thereof, for example, baseband processor 1004A.

The operation flow/algorithmic structure 500 may include, at 504, receiving capability information from coordinating and transmit-only UEs. The capability information may be received as a result of an initial connection procedure, a periodic update (for example, a connection reconfiguration), or based on a request sent by the gNB.

UEs capable of both transmitting and receiving on a sidelink and, potentially, having sufficient platform resources to accommodate coordinating RRP operations, may provide an indication that the UE is capable of operating as a coordinating UE. UEs having only transmit capabilities or, potentially, operating in a transmit-only mode, may provide an indication that they are transmit-only UEs.

The operation flow/algorithmic structure 500 may further include, at 508, configuring the coordinating and transmit-only UEs. The configuration at 508 may include indications to the UEs that they are to operate in the coordinating or transmit-only roles. In some instances, the configuration at 508 may include configuring a transmit-only UE with a resource pool that indicates the gNB is able to assist with RRP.

In some situations, the gNB may configure the UEs (either coordinating or transmit-only UEs) for gNB-assisted RRP based on subscription information associated with the UEs. For example, a transmit-only UE may be associated with the subscription service that enables the gNB-assisted RRP feature. The gNB may verify the subscription settings before providing the configuration information to the transmit-only UE.

The operation flow/algorithmic structure 500 may further include, at 512, receiving a request for an RRP operation from the transmit-only UE. The request may include content information such as that described above with respect to the request at 424 of FIG. 4.

The operation flow/algorithmic structure 500 may further include, at 516, identifying one or more coordinating UEs and transmitting a coordinated RRP request to the identified coordinating UEs. The gNB may identify coordinating UEs based on a coordinating UEs capability or location. For example, it may be desirable for coordinating UEs that are proximate to the transmit-only UE to assist with the RRP operation. Proximity may be determined by both UEs being in a same zone or sector, or may be determined if the UEs location information is sufficient to determine they are within a predetermined distance from one another. Each coordinating UE may have different capabilities including, for example, processing times associated with various RRP operations. In some situations, the gNB may select a coordinating UE based on a processing time constraint received from the transmit-only UE or based on other criteria.

The coordinated RRP request sent to the identified coordinating UEs may be the same as or based on the RRP request received from the transmit-only UE. In some scenarios, the coordinated RRP request may include a subset of the information from the transmit-only UE's RRP request.

The operation flow/algorithmic structure 500 may further include, at 520, relaying the RRP results from coordinating UEs to the transmit-only UE. The relaying of the RRP results may include receiving the RRP results from the coordinating UEs and sending the RRP results to the transmit-only UE.

The results received from the coordinating UE may include an indicator of available/unavailable resources for all selected resources, for each of the selected resources, or for each period as described above with respect to FIG. 4. In some situations, the gNB may simply forward the RRP results to the transmit-only UE. In other situations, the gNB may augment, modify, verify, or alter the RRP results before transmitting to the transmit-only UE.

In some instances, the results may be forwarded to the transmit-only UE based on the processing time of the transmit-only UE. For example, if it is within the processing time of the transmit-only UE (for example, processing constraints indicated by the transmit-only UE), the gNB may send the RRP results to the transmit-only UE. Otherwise, the gNB may not send the results.

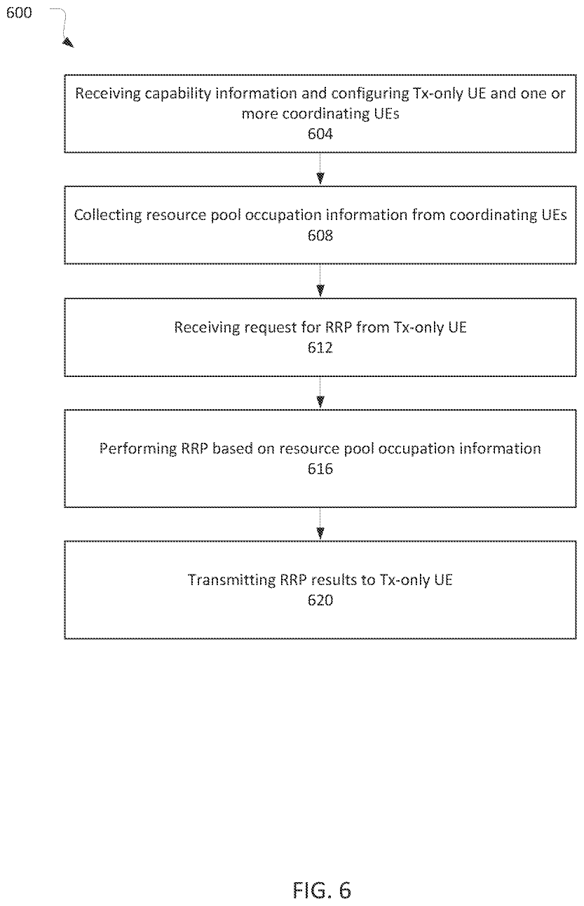

FIG. 6 illustrates an operation flow/algorithmic structure 600 in accordance with some aspects. The operation flow/algorithmic structure 600 may be performed or implemented by a gNB such as, for example, base station 108 or gNB 1000; or components thereof, for example, baseband processor 1004A.

The operation flow/algorithmic structure 600 may include, at 604, receiving capability information from UEs and configuring a transmit-only UE and one or more coordinating UEs. Receipt of the capability information and configuration of the coordinating and transmit-only UEs may be similar to that described above with respect to blocks 504 and 508 of FIG. 5.

The operation flow/algorithmic structure 600 may further include, at 608, collecting resource pool occupation information from one or more coordinating UEs. The coordinating UEs may be configured to transmit resource pool occupation information to the gNB to enable the gNB to have an accurate view of the current state of the resource pool. The gNB may maintain a resource map with the current state of the resource pool. The resource pool occupation information received from the coordinating UEs may include information as to sensed energy levels (or related channel metrics) for each of the resources of the resource pool or reservation information. The reservation information may include an indication of the reserved resources and data priority associated with the reservation.

If the gNB receives the resource pool occupation information from more than one UE, it may bias the received information toward a coordinating UE that is closest to the transmit-only UE. For example, if two different energy levels arc detected for a particular resource, the energy level as seen by a coordinating UE closest to the transmit-only UE may be used.

The operation flow/algorithmic structure 600 may further include, at 612, receiving a request for RRP from the transmit-only UE. The request may include some or all of the content information described above with respect to FIG. 4.

The operation flow/algorithmic structure 600 may further include, at 616, performing the RRP based on the resource pool occupation information. The base station may use the resource map to perform a resource reevaluation similar to that described above with respect to FIG. 2 or resource preemption similar to that described above with respect to FIG. 3 based on the resource map.

The operation flow/algorithmic structure 600 may further include, at 620, transmitting the RRP results to the transmit-only UE. Transmission of the RRP results may be similar to that described above with respect to block 520 of FIG. 5.

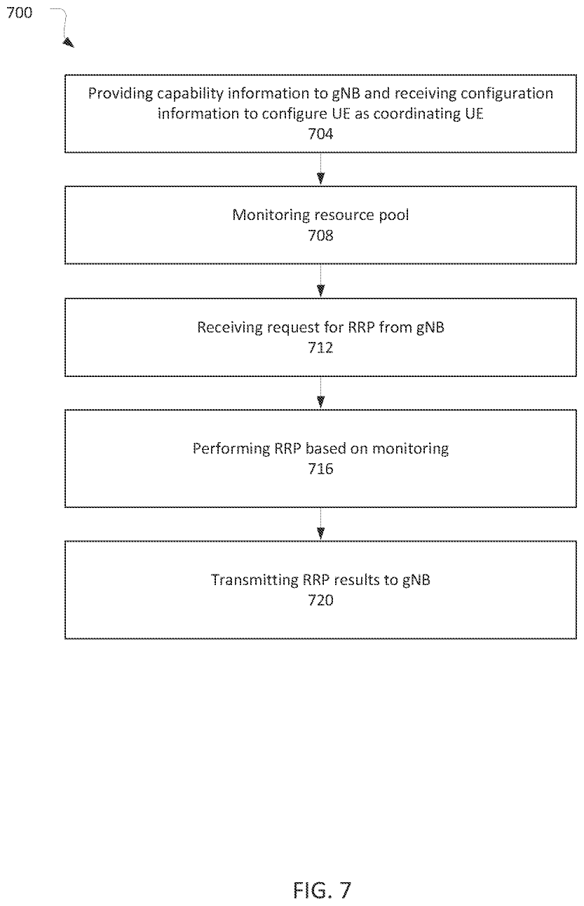

FIG. 7 illustrates an operation flow/algorithmic structure 700 in accordance with some aspects. The operation flow/algorithmic structure 700 may be performed or implemented by a coordinating UE such as, for example, UE 102, or 900; or components thereof, for example, baseband processor 904A.

The operation flow/algorithmic structure 700 may include, at 704, providing capability information to a gNB and receiving configuration information from the gNB to configure the UE as a coordinating UE. Providing the capability information and receiving the configuration information may be similar to that described above with respect to block 504 of FIG. 5.

The operation flow/algorithmic structure 700 may further include, at 708, monitoring the resource pool. The resource pool may be indicated by the configuration information received from the gNB or from a subsequent instruction. The monitoring may include sensing the resources of the resource pool and decoding control information to track reservation information with respect to the resources of the resource pool.

The operation flow/algorithmic structure 700 may further include, at 712, receiving a request for RRP from the gNB. The request may include some or all of the request content discussed above with respect to block 424 of FIG. 4.

The operation flow/algorithmic structure 700 may further include, at 716, performing RRP based on the monitoring.

The operation flow/algorithmic structure 700 may further include, at 720, transmitting the RRP results to the gNB. Transmission of the RRP results may be similar to that described above with respect to block 520 of FIG. 5.

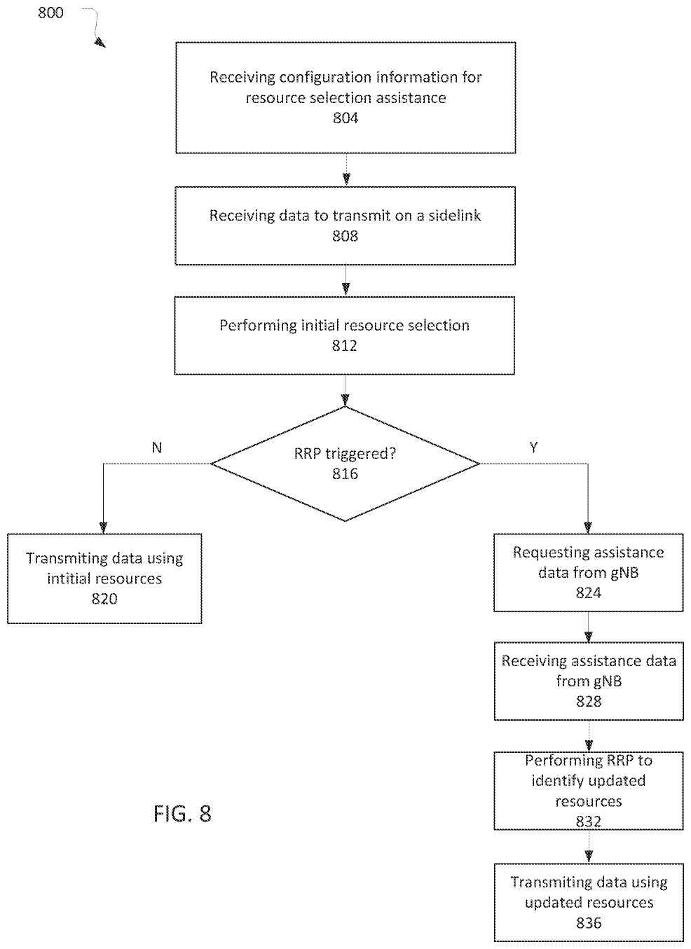

FIG. 8 illustrates an operation flow/algorithmic structure 800 in accordance with some aspects. The operation flow/algorithmic structure 800 may be performed or implemented by transmit-only UE such as, for example, UE 104 or 900; or components thereof, for example, baseband processor 904A.

The operation flow/algorithmic structure 800 may include, at 804, receiving configuration information for resource selection assistance. Configuration of the transmit-only UE for resource selection assistance may be similar to configuring the transmit-only UE for gNB-based RRP described above with respect to block 404 of FIG. 4. In particular, in accordance with one example, the UE may receive a resource pool configuration that indicates a resource selection assistance feature is enabled.

The operation flow/algorithmic structure 800 may further include, at 808, receiving data to transmit on a sidelink, which may be similar to that described above with respect to block 408 of FIG. 4.

The operation flow/algorithmic structure 800 may further include, at 812, performing an initial resource selection, which may be similar to that described above with respect to block 412 of FIG. 4

The operation flow/algorithmic structure 800 may further include, at 816, determining whether an RRP is triggered, which may be similar to that described above with respect to block 416 of FIG. 4.

If, at 816, it is determined that the RRP is triggered, the operation flow/algorithmic structure 800 may advance to transmitting data using resources from the initial resources at 820, which may be similar to that described above with respect to block 420 of FIG. 4.

If, at 816, it is determined that the RRP is not triggered, the operation flow/algorithmic structure 800 may advance to requesting assistance data from the gNB at 824. In some aspects, the request for assistance data may include some or all of the content included in a request to perform an RRP operation as described above with respect to block 424 of FIG. 4.

The operation flow/algorithmic structure 800 may further include, at 828, receiving the assistance data from the gNB. The assistance data may include information similar to some or all of the resource pool occupation information discussed with respect to block 608 of FIG. 6. For example, the assistance data may include information about sensed energy (or channel quality metrics) and reservations with respect to the resources of the resource pool.

In some instances, once the assistance data is requested from the gNB, the gNB may continue to update the assistance data at various intervals. For example, when new information is received by the gNB, the gNB may provide the new information about the resources of the resource pool to the transmit-only UE.

The operation flow/algorithmic structure 800 may further include, at 832, performing an RRP operation to identify the updated resources. The transmit-only UE may perform the RRP operation based on the assistance data received from the gNB in a manner similar to that described above with respect to block 616 of FIG. 6.

The operation flow/algorithmic structure 800 may further include, at 836, transmitting data using the updated resources, which may be similar to block 432 of FIG. 4.

FIG. 9 illustrates a UE 900 in accordance with some aspects. The UE 900 may be similar to and substantially interchangeable with UEs 102, 104, or 106.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, optical connection, etc. that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some aspects, the baseband processor circuitry 904A may access a communication protocol stack 936 in the memory/storage 912 to communicate over a 3GPP compatible network. In general, the baseband processor circuitry 904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some aspects, the PHY layer operations may additionally/alternatively be performed by the components of the RF interface circuitry 908.

The baseband processor circuitry 904A may generate or process baseband signals or waveforms that carry information in 3GPP-compatible networks. In some aspects, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein. The memory/storage 912 may also store configuration, resource pool, or RRP information as described elsewhere.

The memory/storage 912 include any type of volatile or non-volatile memory that may be distributed throughout the UE 900. In some aspects, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various aspects, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, phased array antennas, etc. The antenna 926 may have one or more panels designed for specific frequency bands including bands in frequency ranges 1 and 2.

The user interface circuitry 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors: flow sensors; temperature sensors (for example, thermistors); pressure sensors; barometric pressure sensors; gravimeters; altimeters; image capture devices (for example, cameras or lensless apertures); light detection and ranging sensors: proximity sensors (for example, infrared radiation detector and the like): depth sensors: ambient light sensors; ultrasonic transceivers; microphones or other like audio capture devices; etc.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

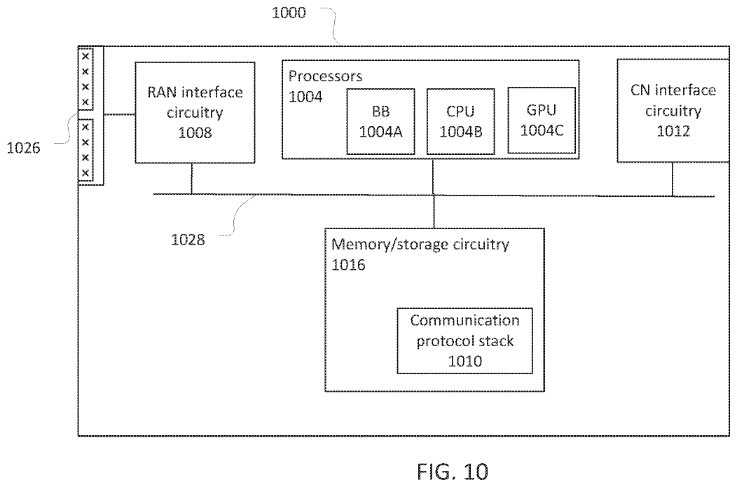

FIG. 10 illustrates a gNB 1000 in accordance with some aspects. The gNB node 1000 may be similar to and substantially interchangeable with base station 108.

The gNB 1000 may include processors 1004, RF interface circuitry 1008, core network (CN) interface circuitry 1012, memory/storage circuitry 1016, and antenna structure 1026.

The components of the gNB 1000 may be coupled with various other components over one or more interconnects 1028.

The processors 1004. RF interface circuitry 1008, memory/storage circuitry 1016 (including communication protocol stack 1010), antenna structure 1026, and interconnects 1028 may be similar to like-named elements shown and described with respect to FIG. 9.

The CN interface circuitry 1012 may provide connectivity to a core network, for example, a 5^{th} Generation Core network (5GC) using a 5GC-compatible network interface protocol such as carrier Ethernet protocols, or some other suitable protocol. Network connectivity may be provided to/from the gNB 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some aspects, the gNB 1000 may be coupled with transmit receive points (TRPs) using the antenna structure 1026, CN interface circuitry 1012, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a user equipment (UE), the method comprising: receiving, from a gNB, configuration information to indicate that gNB-assisted resource reevaluation or preemption (RRP) is enabled for a pool of sidelink resources; randomly selecting initial resources from the pool for transmitting sidelink data; determining whether a gNB-assisted RRP operation is triggered to identify updated resources from the pool; and transmitting the sidelink data using the initial resources or the updated resources.

Example 2 includes the method of example 1 or some other example herein, wherein determining whether the gNB-assisted RRP operation is triggered comprises determining that the gNB-assisted RRP operation is not triggered and the method further comprises: transmitting the sidelink data using the initial resources.

Example 3 includes the method of example 1 or some other example herein, wherein determining whether the gNB-assisted RRP operation is triggered comprises determining that the gNB-assisted RRP operation is triggered and the method further comprises: transmitting, to the gNB, a request to perform the gNB-assisted RRP operation; receiving, from the gNB, an indication of the updated resources; and transmitting the sidelink data using the updated resources.

Example 4 includes the method of example 3 or some other example herein, wherein the indication of the updated resources includes an indicator of available or unavailable resources for all the initial resources: an indicator of available or unavailable resource for individual resources of the initial resources; or an indicator of available or unavailable resources for individual periods of a plurality of periods.

Example 5 includes the method of example 3 or some other example herein, wherein the indication of the updated resources comprises an indication that the initial resources are available to be used as the updated resources and the method further comprises: selecting a subset of the updated resources; and transmitting the sidelink data using the subset of the updated resources.

Example 6 includes the method of example 3 or some other example herein, further comprising: determining, as a result of a previous RRP operation, that first requested resources are not available; and transmitting the request to perform the gNB-assistant operation based on the determining that the first requested resources are not available.

Example 7 includes the method of example 3 or some other example herein, further comprising: determining the updated resources includes a number of resources that is less than a number of resources needed for transmitting the sidelink data; and transmitting the sidelink data on the updated resources and additional, randomly-selected resources of the pool.

Example 8 includes the method of example 1 or some other example herein, wherein determining whether the gNB-assisted RRP operation is triggered comprises:
determining a priority associated with the sidelink data; determining that the gNB-assisted RRP operation is triggered if the priority is greater than a predetermined threshold; and
determining that the gNB-assisted RRP operation is not triggered if the priority is not greater than the predetermined threshold.

Example 9 includes the method of example 1 or some other example herein, wherein determining whether the gNB-assisted RRP operation is triggered comprises: determining that the gNB-assisted RRP operation is triggered if the sidelink data is periodic; and determining that the gNB-assisted RRP operation is not triggered if the sidelink data is aperiodic.

Example 10 includes the method of example 1 or some other example herein, wherein determining whether the gNB-assisted RRP operation is triggered comprises: determining a packet delay budget associated with the sidelink data; determining that the gNB-assisted RRP operation is triggered if the packet delay budget is greater than a predetermined threshold; and determining that the gNB-assisted RRP operation is not triggered if the packet delay budget is not greater than the predetermined threshold.

Example 11 includes the method of example 1 or some other example herein, wherein determining whether the gNB-assisted RRP operation is triggered comprises: determining a time interval between randomly selecting the initial resources and a first-occurring resource of the initial resource; determining that the gNB-assisted RRP operation is triggered if the time interval is greater than a predetermined threshold; and determining that the gNB-assisted RRP operation is not triggered if the time interval is not greater than the predetermined threshold.

Example 12 includes the method of example 1 or some other examp1e herein, further comprising: transmitting, to the gNB, an indication that the UE is a transmit-only UE on a sidelink.

Example 13 includes the method of example 1 or some other example herein, wherein randomly selecting the initial resources is after determining whether the gNB-assisted RRP operation is triggered and comprises: randomly selecting the initial resources with a first random resource selection window if the gNB-assisted RRP operation is triggered; and randomly selecting the initial resources with a second random resource selection window if the gNB-assisted RRP operation is not triggered, wherein the first random resource selection window is larger or later than the second random resource selection window.

Example 14 includes the method of example 1 or some other example herein, wherein determining whether the gNB-assisted RRP operation is triggered comprises determining that the gNB-assisted RRP operation is triggered and the method further comprises: transmitting, to the gNB, a request to perform the gNB-assisted RRP operation, wherein the request includes a resource pool index of the initial resources; a slot index of the initial resources; a sub channel index and number of subchannels of each of the initial resources; a periodicity of the sidelink data or initial resources: a data priority of the sidelink data: an indication whether the request is for resource reevaluation or preemption check; a geographical location of the UE; or a time by which a response to the request is to be received.

Example 15 includes the method of example 14 or some other example herein, further comprising transmitting the request in a physical uplink control channel, a physical uplink shared channel, a radio resource control message, or media access control control element.

Example 16 includes the method of example 1 or some other example herein, wherein the initial resources includes a greater number of resources than needed to transmit the sidelink data.

Example 17 includes the method of example 1 or some other example herein, wherein determining whether a gNB-assisted RRP operation is triggered includes determining that the gNB-assisted RRP operation is triggered and the method further comprises: transmitting, to the gNB, the request for assistance information, the assistance information to include sensing or reservation data related to the pool; receiving, from the gNB, the assistance information; performing a resource reevaluation or preemption based on the assistance information to identify the updated resources; and transmitting the sidelink data on the updated resources.

Example 18 includes a method of operating a gNB, the method comprising: receiving, from a user equipment (UE), a request to perform a resource reevaluation or preemption (RRP) operation or to provide assistance information to facilitate the RRP operation at the UE; obtaining first results that include updated resources or the assistance information; and transmitting, to the UE, an indication of the first results.

Example 19 includes the method of example 18 or some other example herein, wherein the UE is a first UE and the method further comprises: receiving capability information from the first UE to indicate the first UE has transmit-only capabilities with respect to sidelink communications; receiving capability information from a second UE to indicate the second UE is capable of assisting the RRP operation; transmitting first configuration information to the first UE to enable the RRP operation; and transmitting second configuration information to the second UE to configure the second UE as a coordinating UE to assist the RRP operation.

Example 20 includes the method of example 19 or some other example herein, further comprising: selecting the second UE as the coordinating UE based on a proximity of the second UE to the first UE or a processing capability of the second UE.

Example 21 includes the method of example 18 or some other example herein, wherein the request includes initial resources, the first results include updated resources, and the method further comprises: transmitting, to a coordinating UE, a request to perform the RRP operation based on the initial resources; and receiving a response from the coordinating UE, the response to include an indication of the updated resources.

Example 22 includes the method of example 18 or some other example herein, wherein the request includes initial resources, the first results include the updated resources, and the method further comprises: receiving, from a coordinating UE, occupation information with respect to a resource pool and the method further comprises: performing the RRP operation based on the occupation information to identify the updated resources.

Example 23 includes a method of operating a user equipment (UE), the method comprising: receiving, from a gNB, configuration information to configure the UE as a coordinating UE: receiving, from the gNB, a request to assist in a resource reevaluation or preemption (RRP) operation for a transmit-only UE, the request to indicate a pool of sidelink resources; monitoring the pool: and transmitting, to the gNB, results based on the monitoring.

Example 24 includes the method of example 23 or some other example herein, wherein monitoring comprises: sensing resources of the pool to determine energy levels or decoding control information to determine reservation information with respect to the pool.

Example 25 includes the method of example 24 or some other example herein, further comprising: generating resource pool occupation information based on said monitoring: transmitting, to the gNB, the resource pool occupation information as the results.

Example 26 includes the method of example 24 or some other example herein, further comprising: performing the RRP operation based on said monitoring to identify updated resources; and transmitting, to the gNB, an indication of the updated resources as the results.

Example 27 may include an apparatus comprising means to perform one or more elements of a method described in or related to any of examples 1-26, or any other method or process described herein.

Example 28 may include one or more non-transitory computer-readable media comprising instructions to cause an electronic device, upon execution of the instructions by one or more processors of the electronic device, to perform one or more elements of a method described in or related to any of examples 1-26, or any other method or process described herein.

Example 29 may include an apparatus comprising logic, modules, or circuitry to perform one or more elements of a method described in or related to any of examples 1-26, or any other method or process described herein.

Example 30 may include a method, technique, or process as described in or related to any of examples 1-26, or portions or parts thereof.

Example 31 may include an apparatus comprising: one or more processors and one or more computer-readable media comprising instructions that, when executed by the one or more processors, cause the one or more processors to perform the method, techniques, or process as described in or related to any of examples 1-26, or portions thereof.

Example 32 may include a signal as described in or related to any of examples 1-26, or portions or parts thereof.

Example 33 may include a datagram, information element, packet, frame, segment, PDU, or message as described in or related to any of examples 1-26, or portions or parts thereof, or otherwise described in the present disclosure.

Example 34 may include a signal encoded with data as described in or related to any of examples 1-26, or portions or parts thereof, or otherwise described in the present disclosure.

Example 35 may include a signal encoded with a datagram, IE, packet, frame, segment, PDU, or message as described in or related to any of examples 1-26, or portions or parts thereof, or otherwise described in the present disclosure.

Example 36 may include an electromagnetic signal carrying computer-readable instructions, wherein execution of the computer-readable instructions by one or more processors is to cause the one or more processors to perform the method, techniques, or process as described in or related to any of examples 1-26, or portions thereof.

Example 37 may include a computer program comprising instructions, wherein execution of the program by a processing element is to cause the processing element to carry out the method, techniques, or process as described in or related to any of examples 1-26, or portions thereof.

Example 38 may include a signal in a wireless network as shown and described herein.

Example 39 may include a method of communicating in a wireless network as shown and described herein.

Example 40 may include a system for providing wireless communication as shown and described herein.

Example 41 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1-25. (canceled)

26. A method to be implemented by a user equipment (UE), the method comprising:
receiving, from a base station (BS), configuration information to indicate that BS-assisted resource reevaluation or preemption (RRP) is enabled for a pool of sidelink resources;
selecting initial resources from the pool for transmitting sidelink data;
determining whether a BS-assisted RRP operation is triggered to identify updated resources from the pool; and
transmitting the sidelink data using the initial resources or the updated resources.

27. The method of claim 26, wherein selecting the initial resources comprises randomly selecting the initial resources from the pool.

28. The method of claim 26, further comprising:
determining that the BS-assisted RRP operation is not triggered; and
transmitting the sidelink data using the initial resources based on determination that the BS-assisted RRP operation is not triggered.

29. The method of claim 26, further comprising:
determining that the BS-assisted RRP operation is triggered;
transmitting, to the BS, a request to perform the BS-assisted RRP operation;
receiving, from the BS, an indication of the updated resources; and
transmitting the sidelink data using the updated resources.

30. The method of claim 29, wherein the indication of the updated resources includes an indicator of available or unavailable resources for all the initial resources; an indicator of unavailable or unavailable resource for individual resources of the initial resources; or an indicator of available or unavailable resources for individual periods of a plurality of periods.

31. The method of claim 29, wherein the indication of the updated resources comprises an indication that the initial resources are available to be used as the updated resources and the method further comprises:
selecting a subset of the updated resources; and
transmitting the sidelink data using the subset of the updated resources.

32. The method of claim 29, further comprising:
determining, as a result of a previous RRP operation, that first requested resources are not available; and
transmitting the request to perform the BS-assisted operation based on determining that the first requested resources are not available.

33. The method of claim 29, further comprising:
determining the updated resources includes a number of resources that is less than a number of resources needed for transmitting the sidelink data; and
transmitting the sidelink data on the updated resources and at least some of the initial resources.

34. The method of claim 26, wherein determining whether the BS-assisted RRP operation is triggered comprises:
determining a priority associated with the sidelink data;
determining that the BS-assisted RRP operation is triggered if the priority is greater than a predetermined threshold; and
determining that the BS-assisted RRP operation is not triggered if the priority is not greater than the predetermined threshold.

35. The method of claim 26, wherein determining whether the BS-assisted RRP operation is triggered comprises:
determining that the BS-assisted RRP operation is triggered if the sidelink data is periodic; and
determining that the BS-assisted RRP operation is not triggered if the sidelink data is aperiodic.

36. The method of claim 26, wherein determining whether the BS-assisted RRP operation is triggered comprises:
determining a packet delay budget associated with the sidelink data;
determining that the BS-assisted RRP operation is triggered if the packet delay budget is greater than a predetermined threshold; and
determining that the BS-assisted RRP operation is not triggered if the packet delay budget is not greater than the predetermined threshold.

37. An apparatus comprising:
interface circuitry; and
processing circuitry coupled with the interface circuitry, the processing circuitry to:
receive, from a user equipment (UE) via the interface circuitry, a request to perform a resource reevaluation or preemption (RRP) operation or to provide assistance information to facilitate an RRP operation at the UE;
obtain first results that include updated resources or the assistance information; and
transmit, to the UE via the interface circuitry, an indication of the first results.

38. The apparatus of claim 37, wherein the UE is a first UE and the processing circuitry is further to:
receive capability information from the first UE to indicate the first UE has transmit-only capabilities with respect to sidelink communications;
receive capability information from a second UE to indicate the second UE is capable of assisting the RRP operation;
transmit first configuration information to the first UE to enable the RRP operation; and
transmit second configuration information to the second UE to configure the second UE as a coordinating UE to assist the RRP operation.

39. The apparatus of claim 38, wherein the processing circuitry is further to:
select the second UE as the coordinating UE based on a proximity of the second UE to the first UE or a processing capability of the second UE.

40. The apparatus of claim 38, wherein the request includes initial resources, the first results include updated resources, and the processing circuitry is further to:
transmit, to a coordinating UE, a request to perform the RRP operation based on the initial resources; and
receive a response from the coordinating UE, the response to include an indication of the updated resources.

41. The apparatus of claim 38, wherein the request includes initial resources, the first results include the updated resources, and the processing circuitry is further to:
receive, from a coordinating UE, occupation information with respect to a resource pool; and
perform the RRP operation based on the occupation information to identify the updated resources.

42. A user equipment (UE) comprising:
interface circuitry; and
processing circuitry coupled with the interface circuitry, the processing circuitry to:
receive, from a base station (BS) via the interface circuitry, configuration information to configure the UE as a coordinating UE;
receive, from the BS via the interface circuitry, a request to assist in a resource reevaluation or preemption (RRP) operation for a transmit-only UE, the request to indicate a pool of sidelink resources;
monitor the pool to obtain results; and
transmit, to the BS via the interface circuitry, the results.

43. The UE of claim 42, wherein to monitor the pool the processing circuitry is to:
sense resources of the pool to determine energy levels or decode control information to determine reservation information with respect to the pool.

44. The UE of claim 42, wherein the results comprise resource pool occupation information.

45. The UE of claim 42, wherein the processing circuitry is further to:
perform the RRP operation to identify updated resources; and
transmit, to the BS, an indication of the updated resources as the results.
